(19) United States
(12) Patent Application Publication
(10) Pub. No.: US 2019/0098100 A1
(43) Pub. Date: Mar. 28, 2019

(54) SYSTEM AND METHOD FOR ATTRIBUTING USER ACTION TO ENGAGEMENT WITH ONLINE CONTENT

(71) Applicant: Cognant LLC, Mountain View, CA (US)

(72) Inventors: Ethan Anderson, Mountain View, CA (US); Yonatan Ellert, Sunnyvale, CA (US); Ali Sener, Palo Alto, CA (US); Susanna Orr, Palo Alto, CA (US)

(21) Appl. No.: 16/137,839

(22) Filed: Sep. 21, 2018

Related U.S. Application Data
(60) Provisional application No. 62/561,716, filed on Sep. 22, 2017.

(51) Int. Cl. H04L 29/08; A63F 13/88; G06F 17/30

(52) U.S. Cl. CPC H04L 67/22; G06F 17/30867; A63F 13/88

(57) ABSTRACT

A computer-implemented method and corresponding system for determining attribution for an action taken by a user exposed to published content on a plurality of online platforms, the method including receiving an engagement call transmitted by the user's mobile communication device for each engagement with the published content by the user; attributing, based on the engagement calls, the user action to a corresponding content publisher on whose online platform the user engaged with the published content; and facilitating an adjustment of future content presentations based on the attribution.

### CROSS-REFERENCE TO RELATED APPLICATIONS

This application claims the benefit of U.S. Provisional Patent Application No. 62/561,716, filed Sep. 22, 2017, the entire contents of which are incorporated by reference herein.

### BACKGROUND OF THE INVENTION

The present disclosure relates generally to the presentation of digital content by publishers and, in certain examples, to systems and methods for attributing user action to the digital content presentations.

In general, client devices are capable of presenting a wide variety of content, including images, video, audio, and combinations thereof. Such content can be stored locally on client devices and/or can be sent to the client devices from server computers over a network (e.g., the Internet). To watch an online movie, for example, a user of a client device can download a copy of the movie and/or can stream the movie from a content provider. Online content can be provided to client devices by publishers, such as Web sites and software applications.

Users can interact with content in various ways. A user can, for example, view images, listen to music, or play computer games. With certain online content, a user can select the content or a portion thereof and be directed to a Web site where further content can be presented or obtained. In some instances, users can download or receive content in the form of software applications.

### BRIEF SUMMARY OF THE INVENTION

In general, the subject matter of this disclosure relates to attributing user action to items of digital content published on Web sites and/or in software applications by multiple publishers. Prior to taking an action, for example, a user may be exposed to items of content that relate to the user action and/or encourage or elicit user action. The user may view the items of content (e.g., videos, images, and/or audio) and/or may engage with the items of content, for example, by playing a mini-game or interacting with a video. In general, the more the user interacts or engages with an item of content, the more the item of content is likely to encourage the user to take the action. In one example, the systems and methods described herein can be used to measure a user's engagement with various items of content. Based on these measurements, the systems and methods can identify the item(s) of content (and the corresponding publisher) that played the most significant role in encouraging the user to take the action. The user action taken can then be attributed to the identified item(s) of content and/or the corresponding publisher.

Advantageously, by determining or measuring user engagement with published content, the systems and methods described herein are able to achieve a far more accurate attribution of user action to specific publishers or items of published content. This can allow future content presentations to be tailored, as needed, to achieve desired user action. Additionally or alternatively, adjustments can be made to future content presentations, for example, by increasing the use of publishers associated with higher rates of attribution and/or decreasing the use of publishers associated with lower rates of attribution. In another implementation, user engagement may be used as indicia to identify a point(s) during the published content when users begin to exit the published content.

In a first aspect, the subject matter described in this specification relates to a method for determining attribution for an action taken by a user exposed to published content on a plurality of online platforms (e.g., a Web site and/or a software application). In some embodiments, the method includes the steps of: receiving an engagement call transmitted by a user's mobile communication device for each engagement with the published content (e.g., scrolling through the published content, interacting with the published content, playing a mini-version of a game, and any combination thereof) by the user; attributing, based on the engagement calls, the action taken by the user (e.g., installing a new software application) to a corresponding content publisher on whose online platform the user engaged with the published content; and facilitating an adjustment of future content presentations based on the attribution.

In some implementations, each engagement call provides indicia of user engagement with the published content. In some variations, engagement with the published content by the user includes playing a mini-version of a game that corresponds to a full version of a new software application.

In some applications, attributing the action taken by the user includes one or more of: determining a level of engagement, or play, achieved by the user in a mini-version of a game; determining that the corresponding content publisher has a highest priority; attributing the action taken by the user based on a total number of engagement calls; and/or applying a weight factor to the total number of engagement calls, wherein the weight factor can be associated with a level of engagement achieved by the user.

In a second aspect, the subject matter of this disclosure relates to a system for determining attribution for an action taken by a user exposed to published content on a plurality of online platforms (e.g., a Web site and/or a software application). In some embodiments, the system includes one or more computer processors programmed to perform operations that can include: receiving an engagement call transmitted by a user's mobile communication device for each engagement with the published content by the user; attributing, based on the engagement calls, the action taken by the user (e.g., installing a new software application) to a corresponding content publisher on whose online platform the user engaged with the published content; and facilitating an adjustment of future content presentations based on the attribution.

In some implementations, each engagement call provides indicia of user engagement with the published content. In some variations, engagement with the published content by the user includes playing a mini-version of a game that corresponds to a full version of a new software application.

In some applications, attributing the action taken by the user includes one or more of: determining a level of engagement, or play, achieved by the user in a mini-version of a game; determining that the corresponding content publisher has a highest priority; attributing the action taken by the user based on a total number of engagement calls; and/or applying a weight factor to the total number of engagement calls, wherein the weight factor can be associated with a level of engagement achieved by the user.

In a third aspect, the subject matter of this disclosure relates to an article. In some embodiments, the article includes a non-transitory computer-readable medium having instructions stored thereon that, when executed by one or more computer processors, cause the computer processors to perform operations including: receiving an engagement call transmitted by a user's mobile communication device for each engagement with the published content by the user; attributing, based on the engagement calls, the action taken by the user to a corresponding content publisher on whose online platform the user engaged with the published content; and facilitating an adjustment of future content presentations based on the attribution.

### DESCRIPTION OF THE DRAWINGS

FIG. 1 is a schematic diagram of a system for determining attribution for an action taken by a user exposed to content published by a plurality of content publishers, in accordance with certain examples of this disclosure.

FIG. 2 is a schematic diagram of a temporal component of an item of interactive content published at three different times by three different content publishers, in accordance with certain examples of this disclosure.

FIG. 3 is a flowchart of an exemplary method of determining attribution for an action taken by a user exposed to content published by multiple content publishers, in accordance with some embodiments of the present invention.

FIG. 4 is a flowchart of another exemplary method of determining attribution for an action taken by a user exposed to content published by multiple content publishers, in accordance with some embodiments of the present invention.

### DETAILED DESCRIPTION

In certain instances, mobile application developers can rely on an attribution module to attribute a user action (e.g., a mobile application install, and a value associated with the install) to one or more items of published content. Properly attributing application installs to the appropriate items of content can be critically important for content providers, as proper attribution can give the content providers the insights needed to scale up activities on higher performing content while reducing activities on lower performing content. The attribution module can determine which items of content (or corresponding content publishers) to award an install to by considering click calls (created when a user selects or clicks on an item of content) or impression calls (created when a user views an item of content). As a byproduct of collecting impression and click data for attribution purposes, the attribution module can be in a good position to help content providers combat impression or click fraud, by identifying traffic sources driving abnormal impression or click activities.

When considering only non-interactive content, measuring just clicks and/or impressions can answer a few key important questions about the potential impact of the content on the user. That is, the user either clicked or did not, or the content was either viewable or it was not. However, relying on only click or impression calls may not provide insight into any engagement between users and the content, such as interactive content. Advantageously, the systems and methods described herein are able to consider such engagement through the use of engagement calls. When a user engages with an item of interactive content for example, the user's mobile communication device can send an engagement call to the attribution module. The attribution module can determine a level of engagement based on the engagement call. The level of engagement can be used to attribute a subsequent user action (e.g., downloading or installing a software application) to the item of content or to the publisher of the item of content. In various example, “interactive content” can refer to content configured to receive user input or feedback (e.g., from the user's client device). Such interactive content can be or can include, for example, a computer game (e.g., a mini-version of a full game), an interactive image, video, or audio recording (e.g., with question and answer opportunities), a questionnaire, a request for user feedback, and/or any combination thereof. Likewise, “non-interactive content” can refer to content configured to be viewed and/or heard by a user, without receiving any input or feedback from the user. Such non-interactive content can be or can include, for example, a video, an image, and/or an audio recording.

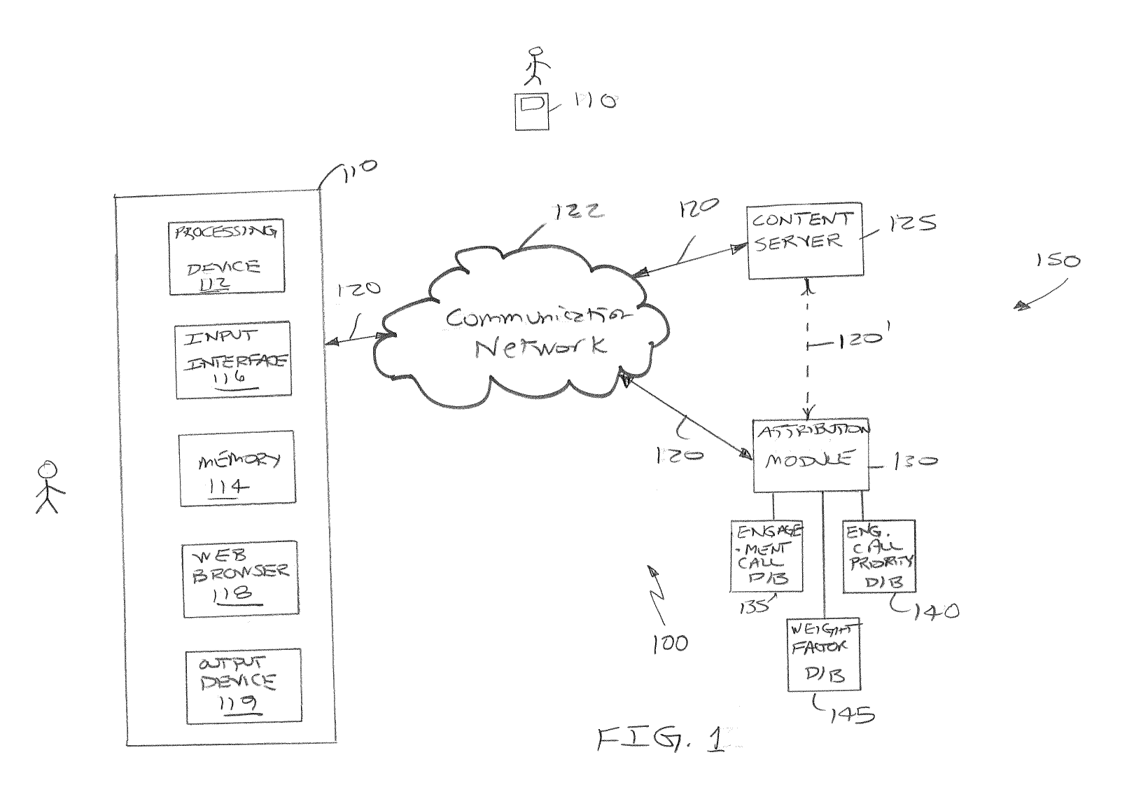

FIG. 1 illustrates an exemplary system 100 for determining attribution for an action (e.g., installing a software application) taken by a user exposed to content published on multiple online platforms (e.g., a Web site, a software application, and so forth). A server system 150 provides functionality for processing data received from, for example, mobile communication devices and determining attribution based on the nature of user interaction or engagement with digital content. The server system 150 can include software components and databases that can be deployed at one or more data centers in one or more geographic locations, for example. In certain instances, the server system 150 is, includes, or utilizes a content server 125, which can be or include a content delivery network (CDN). The server system 150 software components can include an attribution module 130. The software components can include subcomponents that can execute on the same or on different individual data processing apparatus. The server system 150 databases can include, for the purposes of illustration and not limitation, an engagement call 135 database, an engagement call priority 140 database, and an engagement call weight factor 145 database. The databases 135, 140, 145 can reside in one or more physical storage systems. Although the databases 135, 140, 145 in FIG. 1 are shown coupled to the attribution module 130, this is done merely for illustrative purposes. The software components and data will be further described below.

In some implementations, the system 100 can include a Web-based application that can be provided as an end-user application to allow multiple users to interact with the server system 150. The application can be accessed through a communication network 122 (e.g., the Internet, a LAN, a WAN, and the like) by users via a myriad of mobile communication devices 110. As shown in FIG. 1, in some embodiments, a user may use a client device, such as a mobile communication device 110 (e.g., a smartphone, a cellphone, a mobile phone, a tablet computer, or the like) to receive data (e.g., a mobile application, published content, and so forth) from and transmit data to the server system 150, using the communication network 122. Other client devices are possible. Mobile communication device 110 provides an interface by which users may input data and/or interact with content published or otherwise displayed on the mobile communication device 110. In some variations, the mobile communication device 110 can utilize or include, for example, a processing device 112 for processing instructions, a memory 114 for storing data and/or machine-executable instructions, an input interface 116 (e.g., a touch sensitive screen, a keypad, and the like) for interacting with the processing device 112 and/or with a Web browser application 118, and an output device 119 (e.g., a display screen) for displaying data and other content. Other components of the mobile communication device 110 are possible.

In some implementations, a content provider, content publisher, and/or intermediary/third party can cause, from time to time, one or more items of content (e.g., interactive content) to be presented (e.g., displayed) on the output device 119 of the user's mobile communication device 110. In some variations, interactive content transmitted to the user's mobile communication device 110 can be built using, for example, HTML 5 or the like and/or can include, for example, Javascript or similar scripting language that is adapted to accomplish some pre-programmed task upon recognition of some action taken by the receiving user. For the purpose of this disclosure, it can be assumed that the action or actions of the user taken in response to the transmitted interactive content can cause an engagement call(s) 120 to be generated and transmitted to a content server 125 and/or to an attribution module 130 via a suitable communication network 122 (e.g., the Internet).

In various examples, the attribution module 130 can be or can include one or more software components and/or databases that can be deployed at one or more data centers in one or more geographic locations, for example. The attribution module 130 is generally configured to determine attribution based on engagement calls 120 received, for example, directly from the mobile communication device 110 and/or based on engagement calls 120′ received, for example, from the content server 125. In some instances, the attribution module 130 can be, include, or use a mobile measurement partner or a third party attribution service provider. In the depicted example, the content server 125, the attribution module 130, and the mobile communication device 110 can communicate with one another directly and/or using the communication network 122.

Typically, the user, upon viewing the interactive content, may exercise one of several options to engage or otherwise interact (or not) with the content. The user may choose to take no action and ignore the published content (Option A), the user may choose to minimize or delete the published content (Option B), or the user may choose to click on, interact with, and/or engage with the published content (Option C). For the purpose of illustration and not limitation, interacting and/or engaging with the published content can include scrolling through a carousel of user options, playing a mini-version of a game, providing user input or feedback to the content, and so forth. Options A and B, in general, may not trigger a user action (e.g., an installation, a download, or the like) that may be attributed to the published content or for which compensation to the content publisher may be due (e.g., by the content provider). In contrast, Option C may trigger a user action that may be attributed to the published content or for which compensation to the content publisher may be due.

For example, once a user opts for Option C by interacting and/or engaging with the displayed interactive content, the user's actions can trigger an engagement call 120 that is transmitted to the content server 125. Additionally or alternatively, for the purpose of determining attribution, the engagement call 120 can be provided to the attribution module 130 directly via the communication network 122 or the engagement call 120′ can be provided to the attribution module 130 via the content server 125. The number and nature of each engagement call 120, 120′ received from a discrete user can be stored in the engagement call 135 database.

In some applications, attribution can be based on the user's binary decision: whether or not the user interacted or engaged with the interactive content. If the user interacted or engaged with the interactive content (binary 1), then the content publisher may receive attribution and/or be entitled to some compensation for the user's actions. However, if the user did not interact or engage with the interactive content (binary 0), then the content publisher may not receive attribution and/or be entitled to any compensation for the user's actions. In many situations, such a result may be deemed equitable by the content provider and the content publisher. However, in some instances, attribution is not as simple as ones and zeros associated with a binary decision.

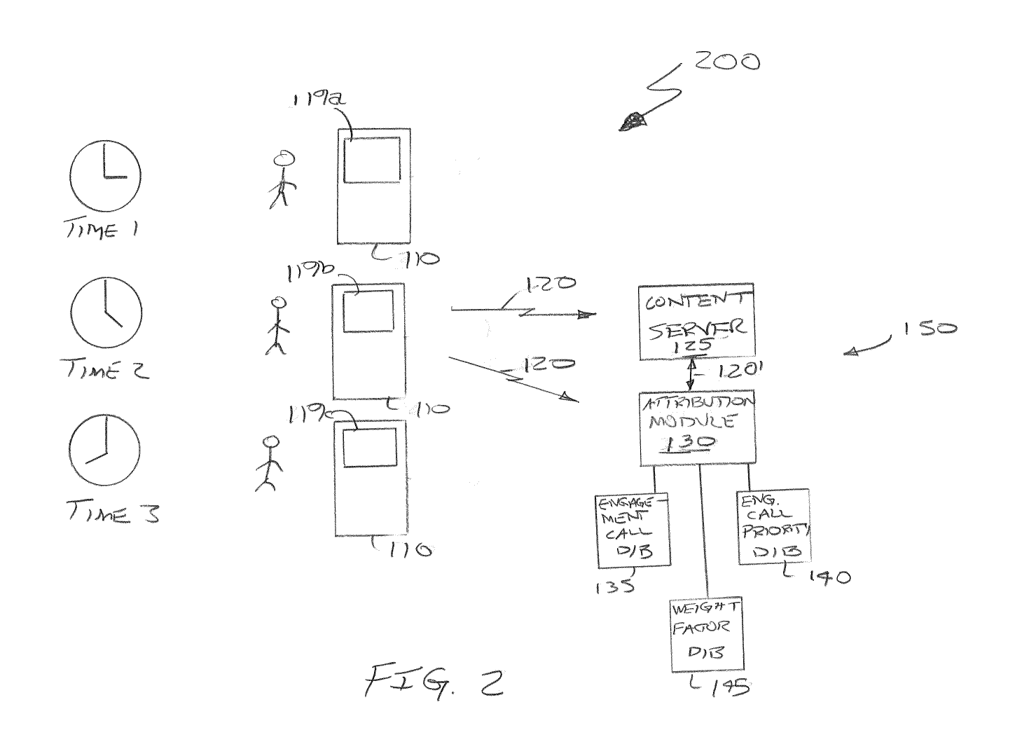

For example, referring to FIG. 2, an exemplary binary engagement call use scenario 200 is shown. According to the scenario 200, over the course of a period of time that can be measured in, for example, seconds, minutes, hours, and so forth, the user may visit the Web sites (or software applications) of three different publishers of the same content, e.g., the same interactive content. From the least recent to the most recent: at time 1, the interactive content may have first been published on the user's display device 119a while the user was on a first publisher's Web site, without the user interacting or engaging with the first (in time) interactive content; at time 2, the interactive content may have later been published a second time on the user's display device 119b while the user was on a second publisher's Web site, with the user interacting or engaging with the second (in time) interactive content; finally, at a later time 3, the interactive content may have been published a third time on the user's display device 119c while the user was on a third publisher's Web site, again without the user interacting or engaging with the third (in time) interactive content. During the interaction with the second interactive content at time 2, while on the second publisher's Web site, the user's interaction can have generated and transmitted an impression or engagement call(s) 120, 120′ to and received by, as previously described, one or more of the content server 125 and the attribution module 130. In some variations, the content server 125 and/or the attribution module 130 can keep track of the number and/or type of engagement calls, e.g., in one or more databases provided for that purpose, occurring during the user's time with each publisher's discrete Web site. Merely for the purposes of illustration and not limitation, the number of engagement calls can be stored in the engagement call 135 database, weight factors assignable to each engagement call can be stored in the weight factor 145 database, and a priority associated with each engagement call can be stored in the engagement call priority 140 database.

Despite occurrence of an impression or engagement call 120 while the user was on the second Web site, a “last touch”-type attribution logic can be configured to attribute the single impression or engagement call 120 to the last Web site visited by the user. Such attribution can fully or substantially compensate the third content publisher to the apparent detriment of the second content publisher, which actually elicited the action on the part of the user that triggered the impression or engagement call 120. Similarly, a “first touch”-type attribution logic can be configured to attribute the single impression or engagement call 120 to the first Web site visited by the user that published the content, which can fully or substantially compensate the first content publisher again to the apparent detriment of the second content publisher. In each of these scenarios, one may conclude that the second content publisher, who received no or only partial compensation, was unjustly denied or inequitably compensated and that the first and third content publishers, who received full or a substantial portion of the compensation, might have been unjustly or inequitably rewarded.

Hence, it is an objective of the systems and methods described herein to recognize and more equitably compensate the second content publisher for driving the download or installation of the subject of the published content (e.g., a mobile application, a game, a survey, and the like). Furthermore, in another embodiment in which the published content can solicit a number of alternative actions by the user for each of which an impression or engagement call 120 can be generated, the attribution solution or model (e.g., the attribution module 130) can also perform attribution commensurate with a degree of user engagement with the published content. More specifically, for a given set of content presentations, the published content may be structured and arranged to enable the user to trigger a first impression or engagement call 120 by simply clicking on the published content (e.g., to play a mini-version of a game). A second impression or engagement call 120 can be generated when the user performs a first action, e.g., in the mini-version of the game. A third impression or engagement call 120 can be generated when the user performs a second action, a fourth impression or engagement call 120 can be generated when the user performs a third action, and so forth. For example, if the game is a baseball mini-game that is being used to solicit the user to download or install a full version of a virtual baseball game on the user's mobile communication device 110, an exemplary first action can include selecting to throw a virtual pitch and/or selecting to swing a virtual bat at a pitch, and the like. A second action can include, for example, opting to steal a virtual base. Additional actions, such as hits, are also possible.

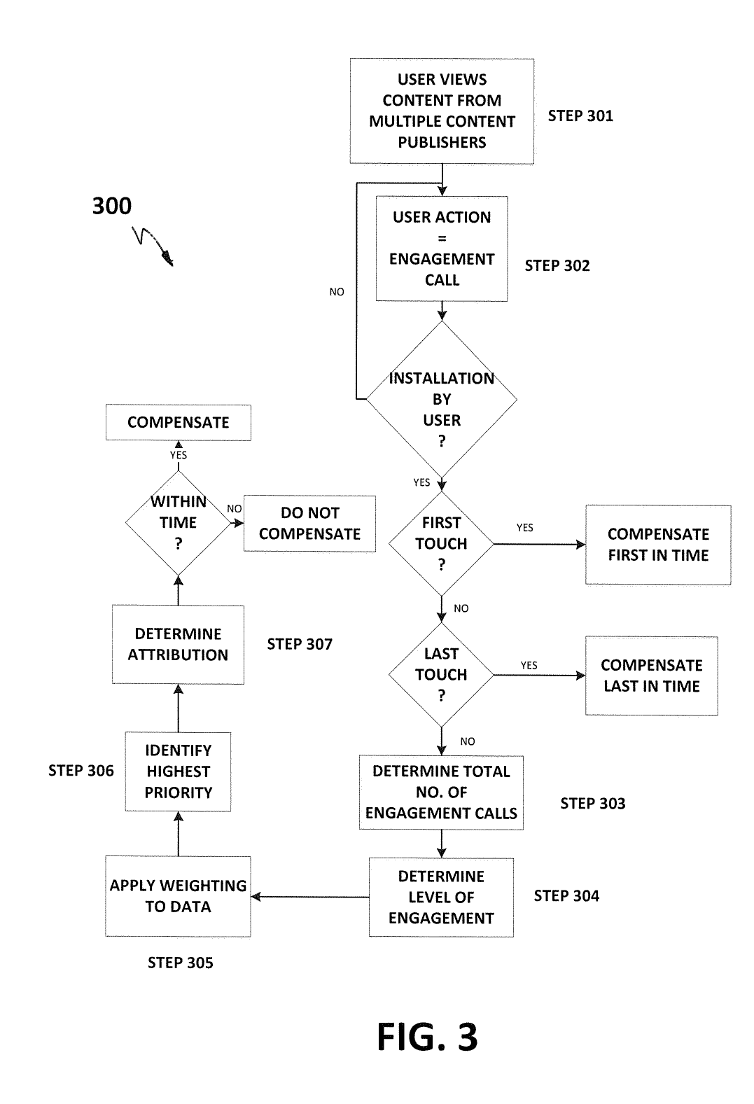

Referring to FIG. 3, an exemplary method 300 for determining attribution is shown. In some implementations, a content provider, content publisher, and/or intermediary or third party can cause, from time to time, one or more items of content (e.g., interactive content) to be presented (e.g., displayed or published) on the output device of the user's mobile communication device (STEP 301). For the purpose of this disclosure, it can be assumed that the user's interaction or engagement with the transmitted interactive content can cause an engagement call to be generated and transmitted to a content server and/or to an attribution module (STEP 302) via a suitable communication network (e.g., the Internet). The number and nature of each engagement call received, as well as the online platform on which the user initiated the action(s) taken can be stored, for example, in an engagement call database.

In various examples, the attribution module is generally configured to determine attribution based on engagement calls received, for example, directly from the mobile communication device and/or based on engagement calls received, for example, from the content server. In some instances, the attribution module can be, include, or use a mobile measurement partner or a third party attribution service provider. In the depicted example, the content server, the attribution module, and the mobile communication device can communicate with one another using the communication network.

Typically, the user, upon viewing the interactive content, may exercise one of several options to engage or otherwise interact (or not) with the content. The user may choose to take no action and ignore the published content, the user may choose to minimize or delete the published content, or the user may choose to click on, interact with, and/or engage with the published content (STEP 302). For the purpose of illustration and not limitation, interacting and/or engaging with the published content can include scrolling through a carousel of user options, playing a mini-version of a game, providing user input or feedback to the content, and so forth. In some instances, the user's selecting either of the first two options may not trigger a user action (e.g., an installation, a download, or the like) that will be attributed to the content or for which compensation to the content publisher may be due (e.g., by the content provider). In contrast, user interaction and/or engagement with the published content (STEP 302) may trigger a user action that can be attributed to the published content or for which compensation to the content publisher may be due.

For example, once a user interacts and/or engages with the displayed interactive content, the user's actions can trigger an engagement call that is transmitted to the content server (STEP 302). Additionally or alternatively, for the purpose of determining attribution, the engagement call can be provided to the attribution module directly via the communication network or the engagement call can be provided to the attribution module via the content server.

In some applications, attribution can be based on the user's binary decision: whether or not the user interacted or engaged with the interactive content. If the user interacted or engaged with the interactive content (binary 1), then the content publisher may receive attribution and/or be entitled to some compensation for the user's actions. However, if the user did not interact or engage with the interactive content (binary 0), then the content publisher may not receive attribution and/or be entitled to any compensation for the user's actions. In many situations, such a result may be deemed equitable by the content provider and the content publisher. However, in some instances, attribution is not as simple as ones and zeros associated with a binary decision.

Accordingly, in some embodiments, in addition to recording the total number of engagement calls generated and received (STEP 303), the present attribution solution or model can also take into account the user's level of engagement (STEP 304) in the object of the published content. Advantageously, the embodied attribution solution or model goes beyond a binary solution, viz., did the user interact or engage with the published content (binary 1) or not (binary 0). Instead, the embodied attribution solution or model measures the number of impression or engagement calls (STEP 303) for each discrete user and/or a level of engagement (e.g., play) reached by the user (STEP 304). In some embodiments, the level of engagement may manifest as an assigned priority that can be stored in an engagement call database. Applying this attribution solution or model to the previous example of three content publishers of the same content visited by a discrete user, the user, in the example, only generated an impression or engagement call while she was on the second content publisher's Web site. For purposes of the present illustration, assume that there are no further impression or engagement calls, or, alternatively, any further impression or engagement calls also occur as a result of the initial action taken by the user while the user is on the second content publisher's Web site. Consequently, a tally of the number of impression or engagement calls can attribute the second content publisher with the highest level of engagement. As a result, all or a substantial portion of the compensation for the user's download or installation of the object of the published content can be attributed to the second content publisher.

In some implementations, for attribution purposes, certain events, actions, or accomplishments of the user that generated an impression or engagement call can be weight-averaged (STEP 305), e.g., using data stored in a weight factor database, in determining an equitable attribution for a subsequent download or installation of a mobile application or other content by the user. Merely for purposes of illustration and not limitation, using a baseball mini-game example, in some variations an impression or engagement call of equal priority or weight can be generated for each swing of the bat, whether the swing results in a strike, a single, a double, a triple, or a homerun. In other variations, impression or engagement calls resulting from bat swings that result in a hit can be assigned a higher priority (e.g., using data from the engagement call priority database) or can be weighted more heavily (e.g., using data from the weight factor database) than a bat swing that results in a strike. Moreover, bat swings that result in a homerun can also be assigned a higher priority (STEP 306) or can be weighted more heavily (STEP 305) than bat swings that result in a triple, a double, or a single. Additionally, bat swings that result in a triple can also be assigned a higher priority (STEP 306) or can be weighted more heavily (STEP 305) than bat swings that result in a double or a single; and so forth. The logic behind assigning a higher priority (STEP 306) or a greater weight (STEP 305) to a “four-bagger” in comparison with a “swing and a miss” stems from the likely greater effect doing well on a baseball mini-game, i.e., hitting a homerun, can have on a user's decision to download or install, for example, a mobile application of the full baseball game than doing less well, i.e., striking out, in the same game can have on the user's download or installation decision.

Those of ordinary skill in the art can appreciate that the assigned priorities (STEP 306) for user accomplishments or weighting factors assigned (STEP 305) can take on any reasonable magnitude subject to the logic behind such assignments. Merely for purposes of illustration and not limitation, in one variation, for the purpose of weight-averaging the results and/or for attributing according to a highest priority in a baseball mini-game, a point value or priority of unity (1) can be assigned to each impression or engagement call for a swinging strike, a point value or priority of two (2) can be assigned to each impression or engagement call for hitting a single, a point value or priority of three (3) can be assigned to each impression or engagement call for hitting a double, a point value or priority of four (4) can be assigned to each impression or engagement call for hitting a triple, and a point value or priority of five (5) can be assigned to each impression or engagement call for hitting a homerun. Such weight factors can be stored in a weight factor database, while priorities can be stored in an engagement call priority database.

Assume that the user played the baseball mini-game on three separate occasions before downloading or installing the (full version) baseball mobile application on her mobile communication device. Exemplary results of the user's engagement, or play, are summarized in Table I.

TABLE I

| | No. of | No. of | No. of | No. of | No. of | Total | Weighted | | |
|---|---|---|---|---|---|---|---|---|---|
| Content | Strikes | Singles | Doubles | Triples | Homeruns | No. of | No. of | Weighted | Highest |
| Publisher | (1)* | (2) | (3) | (4) | (5) | Calls | Calls | Average | Priority |
| A | 30 | 2 | 1 | 0 | 0 | 33 | 37 | 1.12 | 3 |
| B | 5 | 1 | 1 | 1 | 1 | 9 | 19 | 2.11 | 5 |
| C | 10 | 5 | 2 | 2 | 0 | 19 | 34 | 1.79 | 4 |
| TOTAL | 45 | 8 | 4 | 3 | 1 | 61 | 90 | 1.49 | — |

*Weight factors and/or priorities are provide in parentheses.

In some applications, a binary, “first touch”-type attribution logic can be configured to attribute the downloading or installing of the mobile application to content publisher A, while a binary, “last touch”-type attribution logic can be configured to attribute the downloading or installing of the mobile application to content publisher C. However, in accordance with the present invention, the data summarized in Table I—or similar data—can be used to generate a number of potential attribution solutions (STEP 307) that do not simply look at which content publisher was the first, or which was the last. For example, using an attribution solution or model based on a highest priority, i.e., based on the impression or engagement call that has the highest priority associated with it, and/or the level of the user's engagement, the downloading or installing of the mobile application can be attributed to content publisher B since the user hit a homerun (with a priority value of 5) while playing the baseball mini-game provided by content publisher B.

Using an attribution solution or model based on the total number of calls, the downloading or installing of the mobile application can be attributed to content publisher A, which had 33 total calls versus 9 calls for content publisher B and 19 calls for content publisher C. Compensation based on the total number of calls may recognize, for example, that the user spent more time playing the baseball mini-game associated with content publisher A. In a variation of the total number of calls, instead of awarding the entire compensation amount to content publisher A, attribution to each of the content publishers can be proportional based on a ratio of the number of calls on the online platform of each content publisher to the total number of calls on all online platforms. According to this variation, 54% (33/61) of the compensation can be awarded to content publisher A, 15% (9/61) of the compensation can be awarded to content publisher B, and 31% (19/61) of the compensation can be awarded to content publisher C.

In another exemplary attribution solution or model, by applying a weight to each of the datum in the total number of calls, the downloading or installing of the mobile application can be attributed to content publisher A, which had 37 (30×1+2×2+1×3) weighted calls versus 19 (5×1+1×2+1×3+1×4+1×5) weighted calls for content publisher B and 34 (10×1+5×2+2×3+2×4) weighted calls for content publisher C. Compensation based on the weighted number of calls can be configured to recognize, for example, both the amount of time spent and the success of the user playing the baseball mini-game associated with the online platform of content publisher A. In a variation of the weighted number of calls attribution, instead of attributing the entire amount to content publisher A, attribution to each of the content publishers can be adapted to be proportional based on the number of calls. According to this variation, 41% (37/90) of the compensation can be awarded to content publisher A, 21% (19/90) of the compensation can be awarded to content publisher B, and 38% (34/90) of the compensation can be awarded to content publisher C.

In yet another exemplary attribution solution or model, a weighted average per call can be used to attribute the downloading or installing of the mobile application to one or more of the publishers. For example, a weighted average per call can be determined for each content publisher by comparing the quotients of the weighted number of calls divided by the total number of calls. Attribution based on the weighted average per call may recognize, for example, the relative success of the user while playing the baseball mini-game. As shown in Table I, using such an attribution solution or model would compensate content provider B (2.11) versus content provider A (1.12) and content provider C (1.79).

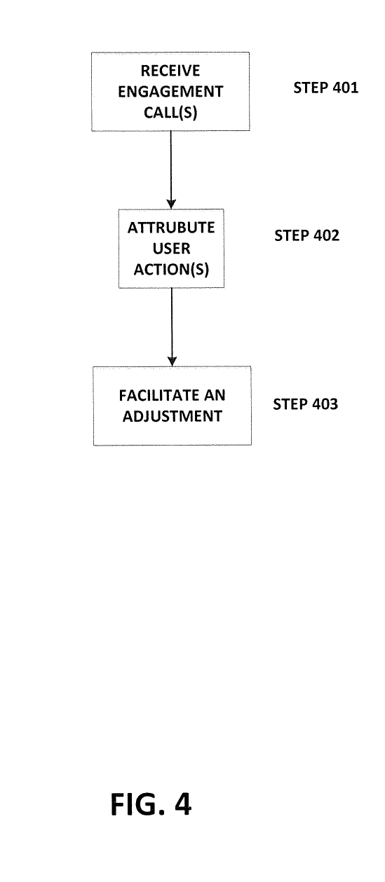

Those of ordinary skill in the art can appreciate that data can be manipulated in a myriad of ways to provide processed data from which compensation can be attributed to one or more of a number of content publishers in a more equitable manner. Indeed, for example, FIG. 4 illustrates an exemplary embodiment of a computer-implemented method for determining attribution for an action taken by a user exposed to published content on a plurality of online platforms (e.g., Web sites, software applications, and so forth). As previously described hereinabove, an engagement call(s) transmitted by the user's mobile communication device can be received for each engagement with the published content by the user (STEP 401). Once these data have been received and processed, based on the nature of the engagement calls (e.g., total number of engagement calls, a weighted number of engagement calls, a priority assigned to discrete engagement calls, and the like), the user action(s) can be attributed to a corresponding content publisher(s) (STEP 402), e.g., on whose online platform the user engaged with the published content. Once an equitable attribution for the user action(s) has been determined, the method and system can adjust future content presentations based on the attribution (STEP 403). For example, such adjustments can be made to future content presentations, for example, by increasing the use of publishers associated with higher rates of attribution and/or decreasing the use of publishers associated with lower rates of attribution

In some embodiments, a temporal factor can also be included in an attribution solution or model. For example, in some implementations, content publishers receiving and/or not receiving attribution can be determined using a temporal window. More particularly, at some point of time corresponding to the occurrence of some event associated with the published content (e.g., a downloading or installing a mobile application), a window of time of a pre-determined temporal length can be created, such that content publishers whose publications elicited some action from the user within the temporal boundaries of the window can be considered for attribution purposes. However, those content publishers whose publications elicited some action from the user but the action occurred outside of the temporal boundaries of the window are not considered for attribution purposes. According to an embodiment, a window of time can be any suitable length of time such as, for example, several seconds, several (e.g., 5) minutes, one hour, six hours, 12 hours, one day, or one week preceding the elicited user action (e.g., downloading or installing a mobile application). An industry standard includes a 28- to 30-day lookback window for click calls and a 1- to 7-day lookback window for impression calls. Those of ordinary skill in the art can appreciate, however, that there is a tradeoff between tight lookback windows and more lengthy lookback windows. For example, a tight lookback window (e.g., of several seconds) may recognize a weak intent by the user to take action (e.g., download or install a mobile application) the lengthier the temporal distance there is between the action taken by the user and an initial or earlier engagement call and, hence, provide little or no attribution to earlier content publishers. For the purpose of establishing a starting or ending point of the window of time, a triggering occurrence can include interacting or engaging with the published content, downloading, installing, or using, for example, a mobile application or other content that is the subject of the published content, and so forth.

The impact of a temporal element in the attribution solution or model can affect each of the examples described hereinabove if one or more of the content publishers are deemed to have elicited some action from the user that occurred outside of the window of time. In short, notwithstanding any of the other factors that can be used to provide a more equitable attribution of compensation for installation or downloading of, for example, a mobile application or other content, the passage of time between user activity associated with the content publishers who fall outside of the window of time serves to eliminate any attribution, reserving any attribution to one or more of the content publishers who remain within the window of time. In some instances, content publications can be weighted according to a distance in time from the elicited user action. For example, content publications that were closer in time to the elicited user action can receive a higher weight, compared to content publications that were more distant in time to the elicited user action. Such weights can increase a likelihood that more recent publications will receive attribution for the elicited user action.

In some instances, the attribution module 130 can be adapted to recognize typical and suspicious user behavior associated with content publications. For purposes of illustration and not limitation, in instances in which a user taps a screen to swing a virtual bat at a virtually pitched ball in a baseball mini-game, each swing may trigger an engagement call 120. The attribution module 130 can process the engagement calls 120 and recognize different patterns between legitimate users that swing the virtual bat at expected intervals commensurate with the timing of the pitches and potentially fraudulent users or bots that interact with the mini-game in unexpected ways, e.g., randomly swinging the virtual bat or not swinging the bat at all, prior to subsequently installing the application associated with the mini-game. User behavior that includes random swinging, constant interval swinging, or non-swinging prior to an installation provides indicia of potentially fraudulent behavior. Once the attribution module has detected patterns indicative of fraudulent traffic and/or activity, the attribution module 130 can filter out or otherwise remove such information from further consideration. Alternatively or additionally, the attribution module 130 can be adapted to inform content providers and/or publishers about the detected fraudulent activity. In some implementations, machine learning can be used to improve the ability of the attribution module 130 to detect fraudulent activity. As the attribution module 130 gathers more and more engagement calls 120, for example, the attribution module 130 or one or more classifiers or models used by the attribution model 130 can be trained to recognize patterns associated with fraud, which can change over time as fraudsters develop new techniques.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A method for determining attribution for an action taken by a user exposed to published content on a plurality of online platforms comprising:
receiving an engagement call transmitted by a user's mobile communication device for each engagement with the published content by the user;
attributing, based on the engagement calls, the action taken by the user to a corresponding content publisher on whose online platform the user engaged with the published content; and
facilitating an adjustment of future content presentations based on the attribution.

2. The method of claim 1, wherein the online platform comprises at least one of a Web site and a software application.

3. The method of claim 1, wherein each engagement call comprises indicia of user engagement with the published content.

4. The method of claim 1, wherein engagement with the published content by the user comprises at least one of scrolling through the published content, interacting with the published content, playing a mini-version of a game, and any combination thereof.

5. The method of claim 1, wherein the action taken by the user comprises installing a new software application.

6. The method of claim 1, wherein engagement with the published content by the user comprises playing a mini-version of a game, and wherein the mini-version of the game corresponds to a full version of a new software application.

7. The method of claim 1, wherein attributing the action taken by the user comprises determining a level of engagement achieved by the user in a mini-version of a game.

8. The method of claim 1, wherein attributing the action taken by the user comprises determining that the corresponding content publisher has a highest priority.

9. The method of claim 1, wherein attributing the action taken by the user comprises attributing the action taken by the user based on a total number of engagement calls.

10. The method of claim 9, wherein attributing the action taken by the user further comprises applying a weight factor to the total number of engagement calls, wherein the weight factor is associated with a level of engagement achieved by the user.

11. A system comprising:
one or more computer processors programmed to perform operations comprising:
receiving an engagement call transmitted by a user's mobile communication device for each engagement with the published content by the user;
attributing, based on the engagement calls, the action taken by the user to a corresponding content publisher on whose online platform the user engaged with the published content; and
facilitating an adjustment of future content presentations based on the attribution.

12. The system of claim 11, wherein the online platform comprises at least one of a Web site and a software application.

13. The system of claim 11, wherein each engagement call comprises indicia of user engagement with the published content.

14. The system of claim 11, wherein the action taken by the user comprises installing a new software application.

15. The system of claim 11, wherein engagement with the published content by the user comprises playing a mini-version of a game, and wherein the mini-version of the game corresponds to a full version of a new software application.

16. The system of claim 11, wherein attributing the action taken by the user comprises determining a level of engagement achieved by the user in a mini-version of a game.

17. The system of claim 11, wherein attributing the action taken by the user comprises determining that the corresponding content publisher has a highest priority.

18. The system of claim 11, wherein attributing the action taken by the user comprises attributing the action taken by the user based on a total number of engagement calls.

19. The system of claim 18, wherein attributing the action taken by the user further comprises applying a weight factor to the total number of engagement calls, wherein the weight factor is associated with a level of engagement achieved by the user.

20. An article, comprising:
a non-transitory computer-readable medium having instructions stored thereon that, when executed by one or more computer processors, cause the computer processors to perform operations comprising:
receiving an engagement call transmitted by a user's mobile communication device for each engagement with the published content by the user;
attributing, based on the engagement calls, the action taken by the user to a corresponding content publisher on whose online platform the user engaged with the published content; and
facilitating an adjustment of future content presentations based on the attribution.
